(19) United States
(12) Patent Application Publication
(10) Pub. No.: US 2016/0307461 A1
(43) Pub. Date: Oct. 20, 2016

(54) CONTROL AND MEASUREMENT TRAINING DEVICE

(71) Applicant: SULTAN QABOOS UNIVERSITY, MUSCAT (OM)

(72) Inventors: SAIF ABDULLAH AL-HIDDABI, MUSCAT (OM); ASIA MOHAMED AL-BUSAIDI, A'SEEB (OM); OMAR SAID AL-ABRI, IBRI (OM)

(21) Appl. No.: 15/194,851

(22) Filed: Jun. 28, 2016

Related U.S. Application Data
(63) Continuation of application No. 14/585,123, filed on Dec. 29, 2014.

(51) Int. Cl. G09B 19/00; G09B 23/10

(52) U.S. Cl. CPC G09B 19/0069; G09B 23/10

(57) ABSTRACT

The control and measurement training device includes a beam pivotally mounted upon a support at one end, with an actuator attached to the opposite end of the beam to adjust the slope or tilt of the beam. A ball travels along the beam, and is retained on the beam by opposite raised stops at the ends of the beam and by lateral wires extending the length of the beam. An optical sensor, e.g., a webcam, is used to sense the position and/or a velocity of the ball as it travels along the beam when the beam is tilted. The two end stops of the beam have differently colored tags thereon, with the ball being a third color. A control system and software are provided to adjust the beam to a slope and level the beam to stop motion of the ball and position or center the ball on the beam.

### BACKGROUND OF THE INVENTION

1. Field of the Invention

The present invention relates to the fields of teaching and training, and particularly to a control and measurement training device including a ball and beam apparatus and a balancing control system therefor.

2. Description of the Related Art

One of the challenges in teaching the subject of process control engineering is to provide the students with experience that includes solid theoretical foundations with practical applications. Students can often have difficulty in connecting the theory that they learn to the practical applications of process control, as can affect their understanding of the subject. Various attempts to assist students in the learning process to aid their understanding of the various aspects of process control engineering have been addressed using three broad approaches, namely computer simulations, laboratory experiments, and case studies. However, computer simulations generally cannot completely duplicate actual systems, and practical operations have features that oftentimes cannot be learned through textbooks.

Also, current methods used in conducting laboratory experiments in teaching process control engineering typically rely upon centralized laboratories, with a relatively large number of students typically gathering for a given lab session. These traditional laboratories are typically relatively costly and the laboratory equipment for demonstrating and teaching process control is generally not easily moveable. Also, such laboratory equipment can require a technical knowledge and expertise for its use and maintenance. Due to time constraints in laboratory access to accommodate increasing numbers of students, it can also be difficult to hold a large number of experiments to desirably cover various aspects of the curriculum.

Further, a relatively large number of participating students can also greatly limit the availability of the experimental apparatus for each student to use individually. In addition, in process engineering laboratories the experimental platforms used in such labs are relatively costly and are generally equipped with sensors that can be difficult to implement in experiments, as well as data from the experiments can be difficult to extract from the sensors. Also, using individual sensors can be challenging, as they typically require some basic knowledge in order to be able to interpret several types of deviations that can occur in real applications.

Educational equipment manufacturers, such as for process engineering laboratory equipment, have been focused on developing devices that were designed to meet certain goals typically without talking into consideration the size of such devices, since such equipment and devices were typically to be installed in a relatively large laboratory. Most such available devices and systems use relatively sophisticated techniques that are generally expensive and/or can be difficult to implement and to extract data therefrom.

An exemplary system might require a large number of different measurements, e.g., angle, velocity, force, temperature, etc., as well as can require additional circuitry, such as for pulse sensing for process engineering measurements, or can require dedicated software for each of specific tasks, for example. Further current systems are often designed to demonstrate a single type of control, such as proportional-integral-derivative (PID) control, linear-quadratic regulator (LQR) control or linear-quadratic Gaussian (LQG) control, and adjustments to the equipment and devices to investigate a different type of control on the equipment or device can be relatively difficult.

Therefore, there is a need for educational control and measurement training devices and apparatuses for process engineering studies having greater simplicity for ease of measurements and data extraction, versatility of operation, such as to implement various types of control, and portability for ease of transport and use in various locations, such as for ease of transport to a classroom for in-class demonstrations.

Thus, a control and measurement training device addressing the aforementioned problems is desired.

### SUMMARY OF THE INVENTION

Embodiments of a control and measurement training device provide a low-cost educational kit that addresses the problems of complexity and lack of portability of conventional laboratory educational equipment for teaching process control engineering. The control and measurement training device includes a visual position information sensor, such as a webcam or camera, which is interfaced with image processing software to detect visual position information of a position of a freely moveable object, such as a ball, on a beam to implement different control strategies using vision control, desirably color-based vision control, to adjust a position of the beam to position the freely moveable object, such as a ball, at a desired position on the beam, based on the detected visual position information from at least one visual position information sensor. Embodiments of a control and measurement training device are desirably relatively light and compact, and can provide portability, such as to facilitate classroom use or for ease of transport, such as to enable use of the control and measurement training device away from a school environment, as to enable performing homework assignments, for example.

Embodiments of a control and measurement training device can therefore provide an economical, mobile optical ball-on-beam platform for control and measurement systems, such as for teaching and/or training. Thus, the present control and measurement training device provides an innovative learning tool that can facilitate students to design, implement, and test different control and measurement strategies.

Embodiments of the control and measurement training device include a beam that is pivotally attached to a support at one end, with the opposite end supported by an actuator to drive that end of the beam up and down to tilt the beam as desired. A ball, or other freely moveable object, is placed on the beam, and is restricted to travel along the beam by a raised stop at each end of the beam and by lateral retaining wires along the beam. A control system is provided to measure the position of the ball along the beam, based on visual position information detected by at least one a visual position information sensor, and to drive the actuator to adjust the angle of the beam to stabilize movement and position of the ball along the beam using vision control, desirably color-based vision control.

Embodiments of a control and measurement device utilize an optical system and a control system using vision control, desirably color-based vision control, to determine the position, as well as a velocity of the ball, as it travels along the beam. Use of a visual position information sensor and implementing vision control, such as color-based vision control, can substantially reduce problems with friction due to mechanical contact of the ball with sensing devices, and can enhance improving reliability and repeatability of the operation of the control and measurement device. The optical system including the at least one visual position information sensor desirably recognizes different color representations, such as two differently colored tags, at the ends of the beam, with the ball that travels along the beam having a third color, to implement color-based vision control to determine a position of the ball on the beam, based on the detected visual position information.

These and other features of the present invention will become readily apparent upon further review of the following specification and drawings.

### BRIEF DESCRIPTION OF THE DRAWINGS

FIG. 1 is a perspective view of an embodiment of a control and measurement training device according to the present invention.

FIG. 2A is a front elevation view of an embodiment of a ball and beam apparatus of embodiments of a control and measurement training device according to the present invention, illustrating the ball and beam apparatus with a downward slope to the right.

FIG. 2B is a front elevation view of an embodiment of a ball and beam apparatus of embodiments of a control and measurement training device according to the present invention, illustrating the ball and beam apparatus with a downward slope to the left.

FIG. 3A is a schematic illustration of an embodiment of a control system and control processes to implement color-based vision control in embodiments of a control and measurement training device according to the present invention.

FIG. 3B is a block diagram illustrating a generalized control system to implement control processes for color-based vision control in embodiments of a control and measurement training device according to the present invention.

FIG. 4 is a chart showing a linear relation of pulse width modulation versus the position of the ball along the beam in an embodiment of a ball and beam apparatus using color-based vision control in embodiments of a control and measurement training device according to the present invention.

Unless otherwise indicated, similar reference characters denote corresponding features consistently throughout the attached drawings.

### DETAILED DESCRIPTION OF THE PREFERRED EMBODIMENTS

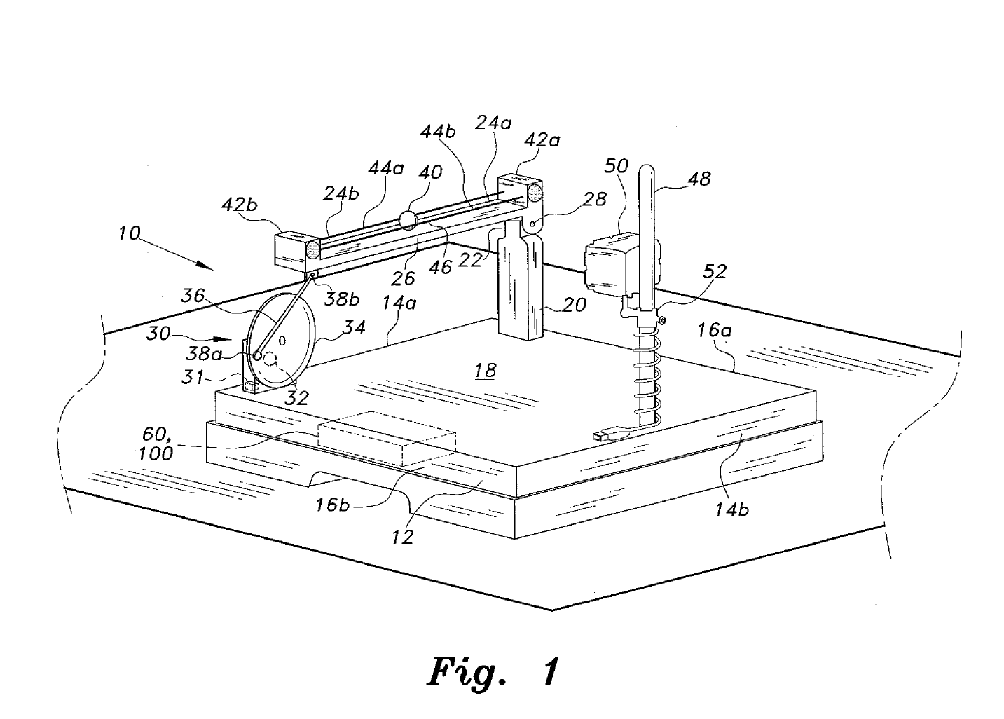

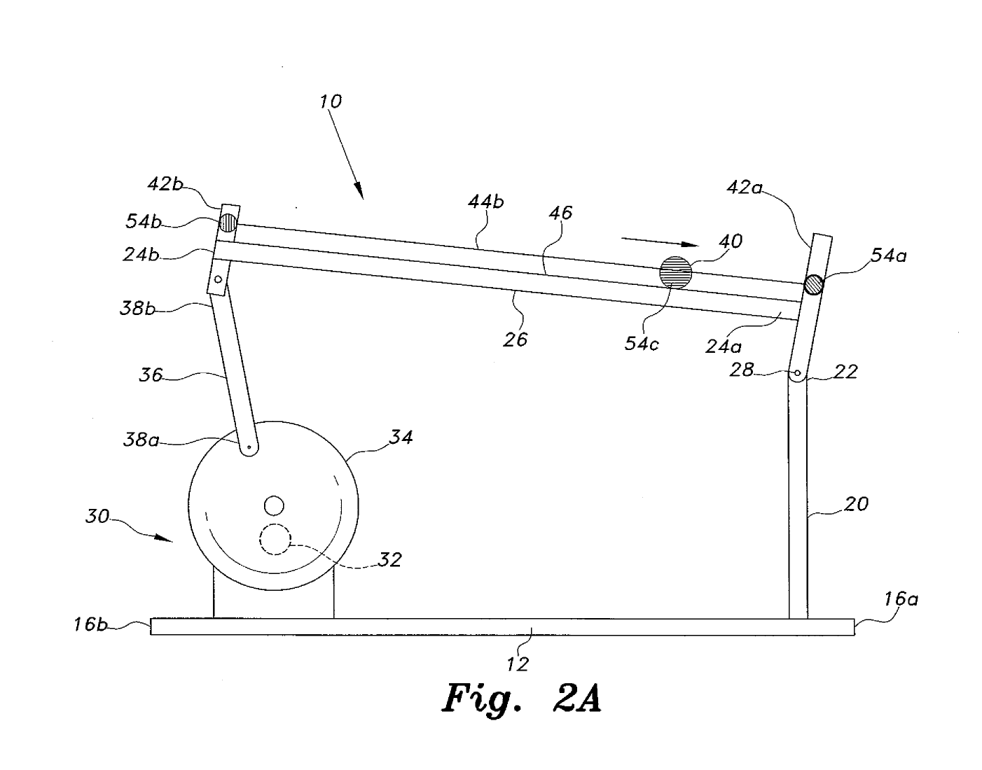

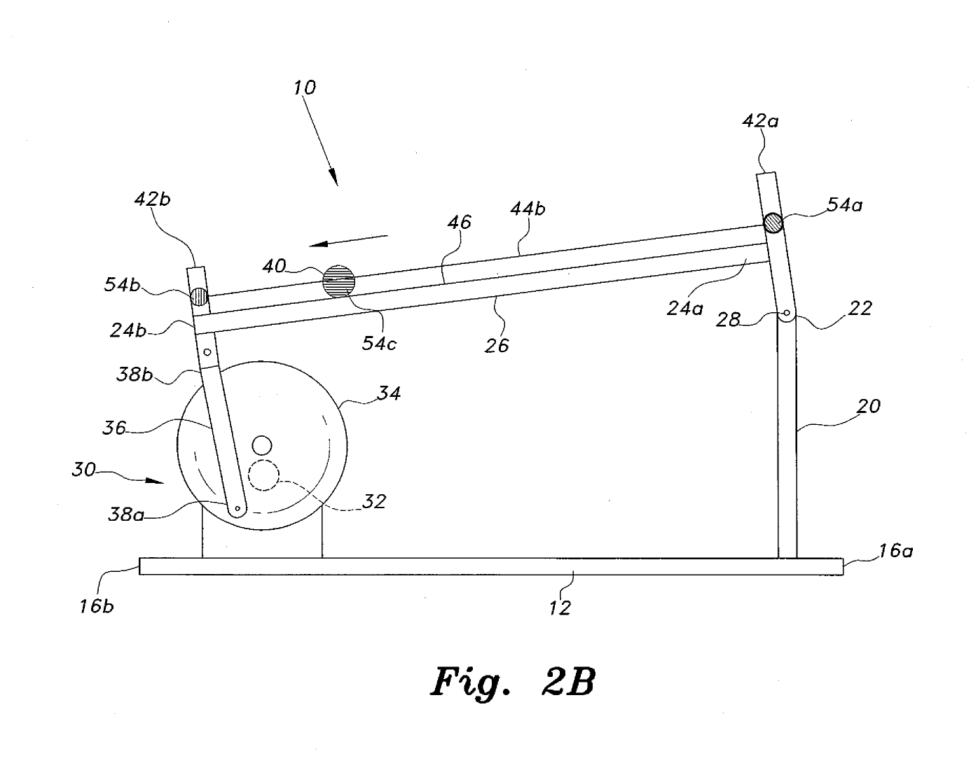

Embodiments of a control and measurement training device, such as the control and measurement training device 10, are relatively small and portable devices capable of placement upon a desktop or similar area, for training students and demonstrating control and measurement systems and procedures. FIG. 1 illustrates the basic structure of an embodiment of the control and measurement training device 10, with FIGS. 2A and 2B showing the mechanical operation of the control and measurement training device 10. As described herein, embodiments of the control and measurement training device 10 use vision techniques to measure the ball on beam system characteristics and use the vison-based measurements as a feedback to a control unit, which performs calculations or determinations, based on detected visual position information to implement necessary changes in the system operating conditions to achieve a desired result in relation to the position of the ball, or other suitable freely moveable object, on the beam, for example.

The control and measurement training device 10 includes a low, flat, portable base 12 having opposed first and second sides 14a and 14b, opposed first and second ends 16a and 16b, and an upper surface 18. The base 12 desirably can be a square or rectangular platform, but the size and configuration of the base 12 is not limited thereto, as can depend on the use or application, and should not be construed in a limiting sense.

A beam support 20 extends upward from and substantially normal to the upper surface 18 of the base 12, adjacent the corner defined by the first side 14a and the first end 16a. The beam support 20 has an upper end 22, to which the first end 24a of a substantially rigid, elongate beam 26 is attached by a pivot 28. The beam 26 can be made of various suitable materials, such as suitable metals or plastics, or combinations thereof, as can depend on the use of application and should not be construed in a limiting sense. The opposite second end 24b of the beam 26 is supported and actuated by a beam tilt actuator 30 extending upwardly from the upper surface 18 of the base 12, adjacent the corner defined by the first side 14a and the second end 16b.

The beam tilt actuator 30 includes a drive motor, such as a servomotor 32, that provides a driving force to drive a drive member, such as a rotary drive member, as a rotary drive wheel 34, for example. A connecting member, such as a connecting rod 36, is communicatively connected to the drive member, such as the rotary drive wheel 34, and to the beam 26. The servomotor 32 (shown in broken lines in FIGS. 1 through 2B) provides a driving force that selectively drives movement of the drive member, such as the rotary drive wheel 34, that selectively moves the connecting member, such as the connecting rod 36, to selectively move the beam 26 so as to adjust a position of the beam 26, such as the angle of the beam 26, for example. The connecting member, such as the connecting rod 36, has a first end 38a pivotally attached eccentrically to a rotary drive member. such as the rotary drive wheel 34, i.e., radially offset from the center of the rotary drive 34, for example. The opposite second or distal end 38b of the connecting rod 36 is pivotally attached to the second end 24b of the beam 26.

Thus, it will be seen that rotation of the rotary drive wheel 34 beneath the second end 24b of the beam 26 results in the connecting rod 36 oscillating or reciprocating movement of the second end 24b of the beam 26, thereby changing or adjusting the slope or tilt of the beam 26. The connecting rod 36 is therefore operatively connected to the servomotor 32, such that as the servomotor 32 turns or operates, the connecting rod 36 raises and lowers a distal end of the beam 26 to thereby selectively control the motion of a freely moveable object, such as a spherical ball 40, on the beam 26.

A freely moveable object, such as the spherical ball 40, is placed atop the beam 26, and is free to roll or move from end to end thereon. The freely moveable object, such as the spherical ball 40, can be of any of various suitable shapes or configurations, such as spherical, generally rounded, oval, rectangular or square shaped, but is not limited thereto, and has a surface adapted to be positioned adjacent the beam 26 that is formed of a material or construction so as to be freely moveable thereon, such as a surface having a relatively low coefficient of friction, for example.

The ball 40 is retained atop the beam 26 by opposed first and second stops 42a and 42b extending upward from the respective ends 24a and 24b of the beam 26, and by laterally opposed first and second object retaining members, such as first and second ball retaining wires 44a and 44b extending between the two stops 42a and 42b, so as to restrict the movement of the freely moveable object, such as the ball 40, when placed on top of the beam 26 to substantially one dimensional movement relative to the beam 26, which is generally along the length of the beam 26. Between the first and second ball retaining wires 44a, 44b there is defined an object travel track, such as a ball track 46, with the freely moveable object, such as the ball 40, being restricted to travel along the ball track 46 by the first and second ball retaining wires 44a, 44b and the stops 42a, 42b. The ball retaining members, such as the first and second ball retaining wires 44a and 44b, can be made of various suitable materials, such as a string or plastic type material, as can depend on the use or application, and should not be construed in a limiting sense.

The use of thin wires for the first and second ball retaining wires 44a, 44b, as a lateral retaining means, for the freely moveable object, such as the ball 40, allows the position of the ball 40 to be viewed readily by a visual position information sensor 50, described further below. The first and second ball retaining wires 44a, 44b are desirably used in that they do not substantially block the view of the freely moveable object, such as the ball 40, by the visual information position sensor 50, and, hence, the ball 40 and its position can be easily detected by the visual information position sensor 50, such as an optical color sensor, such as a color camera or a color webcam, for example. Also, use of the first and second ball retaining wires 44a, 44b as the first and second retaining members, can advantageously reduce the weight and the cost of the control and measurement training device 10.

Desirably, the beam 26 is formed of a relatively hard material for substantial rigidity and to provide a relatively low friction surface for the ball track 46, with the freely moveable object, such as the ball 40, desirably being formed of a relatively hard steel, e.g., a ball from a ball bearing or the like, or the freely moveable object, such as the ball 40, can be formed of other suitable material, as can depend on the use or application, and should not be construed in a limiting sense. Use of such material for the freely moveable object, such as the ball 40, and for the object travel track, such as the ball track 46, typically results in a relatively low friction between the freely moveable object, such as the ball 40, and its object travel track, such as the ball track 46, with what relatively small amount of friction that can occur being primarily a result of contact between the freely moveable object, such as the ball 40, and the lateral first and second object retaining members, such as the first and second ball retaining wires 44a, 44b. This can be advantageous for the control system used in the device 10, as the reduction of hysteresis can facilitate the operation of the control system in adjusting a position of the freely moveable object, such as the ball 40, to a desired position on the beam 26. The freely moveable object, such as the ball 40, will tend to move or roll from left to right when the rotary drive wheel 34 is rotated to lift the second end 24b of the beam 26 via the connecting rod 36 to tilt the beam 26 down to the right, as shown in FIG. 2A, with the rolling tendency of the ball 40 being reversed when the rotary drive wheel 34 is rotated to lower the second end 24b of the beam 26, as shown in FIG. 2B.

A substantially vertical sensor support mast 48 extends upwardly from the upper surface 18 of the base 12 adjacent the second side 14b thereof, opposite the beam 26. A visual position information sensor 50 is adjustably mounted on the mast 48 by a vertically adjustable clamp or holder 52, for example. The visual position information sensor 50 is desirably a single universal serial bus (USB) color webcam capable of detecting and registering various colors in the normal visual spectrum, i.e., the electromagnetic spectrum in a range of from between about 4,000 angstroms to about 7,000 angstroms. Typically, three distinct colors are respectively provided on the two stops 42a and 42b, and on the freely moveable object, such as the ball 40. For example, the first stop 42a can have a green first color representation, such as a tag or target 54a, the opposite second stop 42b can have a red second color representation, such as a tag or target 54b, and the freely moveable object, such as the ball 40, can be colored blue, as indicated by a third color representation 54c on the ball 40 as shown in FIGS. 2A and 2B. These colors are exemplary and are easily distinguished from one another by a person with normal color vision and also by a USB color webcam or a color camera, desirably used as the visual position information sensor 50, for example.

Various other suitable colors can be used as the first, second and third color representations desired, so long as they are readily distinguishable from one another by the visual position information sensor 50, as can depend on the use or application, and should not be construed in a limiting sense. The use of the visual position infotmation sensor 50 that is capable of distinguishing color, and the use of different color tags or targets, can reduce the number of sensors that would otherwise be required and can allow substantially all of the sensing functions to be carried out by a single sensor. Use of the visual position information sensor 50 can be particularly advantageous, in this regard, in comparison to various other types of systems and/or sensors for position detection, e.g., resistive strip sensors, infrared and sonar or ultrasonic sensors, phototransistors, electromagnetic devices, etc.

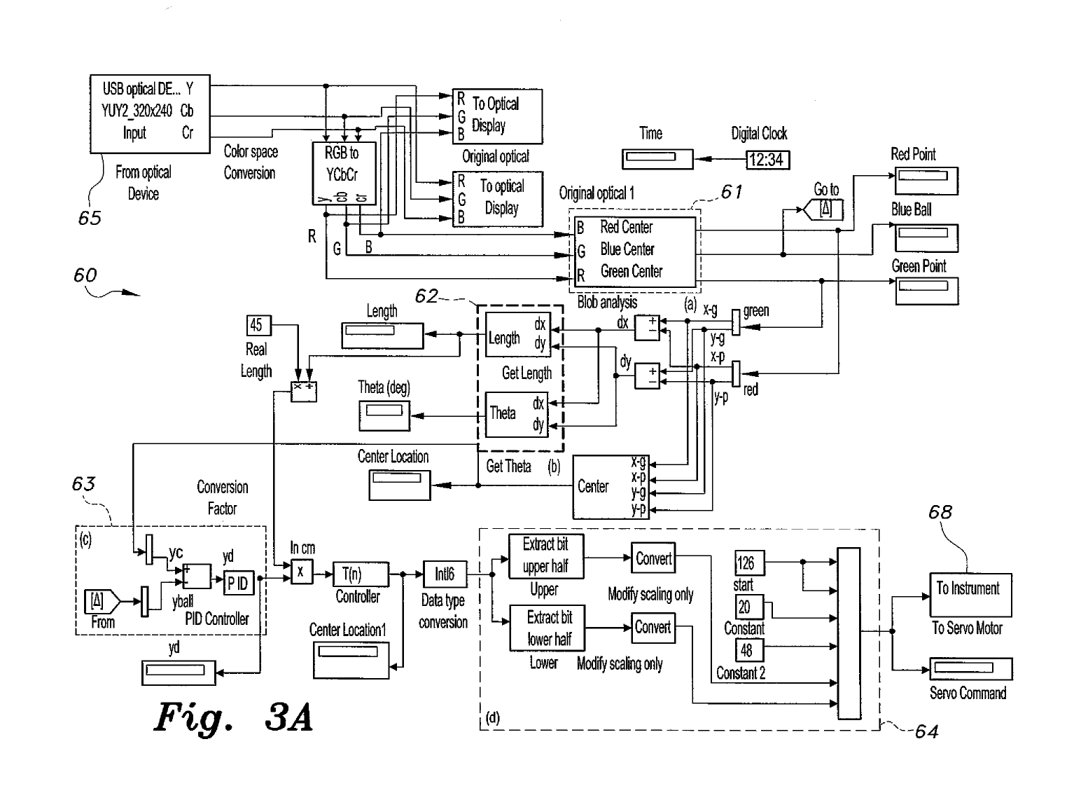

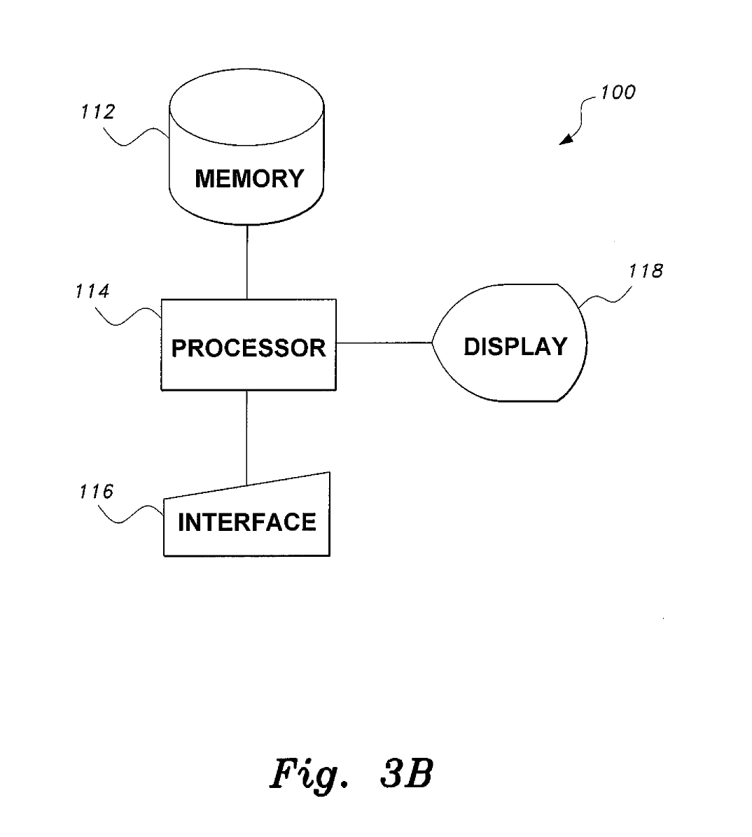

FIG. 3A is a schematic chart showing an embodiment of a control system 60, such as can be in communicating relation with or in conjunction with a servo controller 31 to control operation of the servomotor 32 and in communicating relation with or in conjunction with the visual position information sensor 50 to control operation of the servomotor 32 to implementing control processes for a control and measurement training device, such as the control and measurement training device 10. A servo controller 31 that can be used to control the servomotor 32 is a commercial SC-8000 Servo Controller, for example, but other suitable servo controllers can be used, as can depend on the use or application, and should not be construed in a limiting sense.

FIG. 3A provides a schematic diagram of the operating or control system 60 for the control and measurement training device 10. It will be seen that as the beam 26 tilts toward one end or the other, the ball 40 will accelerate toward the low end of the beam 26 due to gravity. This acceleration is essentially proportional (neglecting friction) to the slope of the beam 26. Thus, a feedback mechanism typically is employed in order to adjust the slope of the beam 26 according to the position and motion of the freely movable object, such as the ball 40, such as to position the freely movable object, such as the ball 40, at a desired location on the beam 26. Such a feedback mechanism typically requires the use of a real time tracking and sensing mechanism that will indicate the position of the freely movable object, such as the ball 40, along the beam 26 as the slope of the beam changes, as well as can indicate beam angle changes of the beam 26.

Any of various suitable software programs or systems can be adapted for use in controlling the control and measurement training device 10, as can depend on the use or application, and should not be construed in a limiting sense. As an example, software that can be used in implementing control of the position of the freely movable object, such as the ball 40, on the beam 26 includes that using a Simulink toolbox in MATLAB, for example. Software, such as that using the Simulink toolbox in MATLAB, is loaded into a computer or computer device, as can include the control system 60 associated with the control and measurement training device 10, in order to display and analyze the object-on-beam apparatus, such as the ball-on-beam apparatus, characteristics related to the position of the freely movable object, such as the ball 40, on the beam 26 either locally or alternatively remotely via the internet, for example. In addition, the software implemented by the control system 60 selectively and/or automatically controls the servomotor 32, such as by the control system 60 generating and sending control signals, such as commands, to the servo controller 31 to actuate the servomotor 32 to move the beam 26 to position or maintain the freely moveable object, such as the ball 40, at a desired position, such as at a center of the beam 26, using optical or visual feedback from the visual position information sensor 50, such as an optical sensor, such as a webcam or a camera, desirably an optical color sensor, such as a color webcam or a color camera.

The control and measurement training device 10 uses a vision control scheme, such as desirably a color-based vision control scheme, to control the system operation to adjust and selectively control the position of the freely moveable object, such as the ball 40, on the beam 26. Desirably, three color representations of different colors, one each for the freely moveable object, such as the ball 40, and one for each of the two ends of the beam 26, such as for the two stops 42a and 42b, of the control and measurement training device 10. However, other suitable visual control indicators of schemes can be employed for the color representations, as can depend on the use of application, and should not be construed in a limiting sense. The visual position information sensor 50, such a universal serial bus (USB) webcam, desirably a universal serial bus (USB) color webcam, or other suitable optical sensor or camera, is mounted on the control and measurement training device 10 to provide an optical input and detected visual position information to the control system 60 and/or a computer or computing device, such as including or associated with the control system 60, including a controller/processor, to provide detected visual position information as to a position of the freely moveable object, such as the ball 40, relative to the beam 26, and a position of the beam 26.

The visual position information sensor 50, such as an optical sensor, as a webcam or a camera, is interfaced with image processing software to detect visual position information of a position of a freely moveable object, such as the ball 40, on the beam 26 to implement by the control system 60, such as by a controller including a processor, different control strategies using vision-based control, such as desirably color-based vision control, to adjust a position of the freely moveable object, such as the ball 40, on the beam 26, by adjusting a position of the beam 26, based on the detected visual position information from at least one visual position information sensor 50.

A primary point of the imaging processing software in implementing control of the freely movable object, such as the ball 40, on the beam 26 by the control and measurement training device 10 is to take “snapshots” of the freely movable object, such as the ball 40, and/or the beam 26 while in motion, and then to use these “snapshots” to depict the positions of the color representations, such as targets or tags 54a, 54b associated with the two stops 42a and 42b and the color representation associated with freely moveable object, such as the ball 40, color representation 54c, as corresponding to colored target areas and an object, or a ball, area of system, respectively. These color target areas and object, or ball, areas can be referred to “virtual sensors”.

The virtual sensors, and their corresponding respective color representations, can be provided in the control and measurement training device 10, such as by painting small areas on the outside surface of the components, such as mainly on the image area of the stops 42a and 42b and on the freely moveable object, such as the ball 40, scanned or viewed by the visual position information sensor 50, of the system being monitored, or by sticking or placing pieces of paper, plastic, tape or any other comparable materials of suitable colors on the respective components, provided that the respective colors are different from that of the rest of the image being detected by the visual position information sensor 50, for example, and should not be construed in a limiting sense.

After characterizing the color representations 54a, 54b and 54c to provide corresponding respective color representations as the virtual sensors, the image frames corresponding to the motion of the freely movable object, such as the ball 40, and beam 26 are obtained by the visual information position sensor 50 and processed by the control system 60. The pixels corresponding to the detected color representations 54a, 54b and 54c corresponding to the virtual sensors are segregated from the remainder of the image using a threshold filtering process. Then the positions of the centroid of the freely moveable object, such as the ball 40, and the beam 26 are calculated or determined for every image frame or substantially every image frame, and the real movement coordinates are determined by a scale factor matching or associating the pixels to the actual dimensions, for example.

For relatively easier processing of the detected image, the detected image is generally transferred from a true color scheme, such as the true colors of the color representations 54a, 54b and 54c (e.g., red, green, and blue), into a gray scale and then finally into binary format with black and white pixels only, for example, although such processing should not construed in a limiting sense in this regard, as other suitable processing can be used, as can depend on the use or application. These black/white pixels are typically represented by a logical layout of binary characters of 0 (off pixels) and 1 (on pixels), for example. The desired MATLAB program used with embodiments of the control and measurement training device 10 includes Image Acquisition Toolbox and Image Processing Toolbox subroutines, which can assist further in facilitating the operation and control system, such as implemented by the control system 60, in performing operations related to the detected position of the freely moveable object, such as the ball 40, on the beam 26 or the adjustment of the freely moveable object, such as the ball 40, to a desired position on the beam 26, for example.

Therefore, the analysis environment of the control and measurement training device 10, as described, is relatively significantly advantageous, particularly when compared to image processing systems that usually need devoted software to execute their functions, with such software packages being often highly priced and typically are not straightforward to be adapted by the final user in implementing a control process.

In contrast, embodiments of a control and measurement training device, such as the control and measurement training device 10, desirably implement control using the visual position information sensor 50, the servo control by the servo controller 31 of the servo motor 32, the virtual sensors corresponding to the color representations 54a, 54b and 54c and the control system 60 that respectively performs the tasks starting from data collection, analysis, controlling and sending feedback signal(s) or control signal(s) to the beam tilt actuator 30 in order to perform the required or desired corrections that will bring the system towards the desired behavior related to the position of the freely movable object, such as the ball 40, with relative simplicity, ease and portability of use, for example.

In this regard, in the control system 60, implementing operation of a control process to control a position of the freely moveable object, such as the ball 40, on the beam 26, the detected visual position information or data is analyzed and processed, such as by using suitable MATLAB/Simulink programming and processing operations. Programming and instructions operating on a controller/processor of the control system 60 implement tracking the freely moveable object's, such as the ball 40's, location and measuring the beam angle of the bema 26, such as relative to a horizontal position of the beam 26, to provide position control of the freely moveable object, such as the ball 40, to position the freely moveable object, such as the ball 40, at a desired position on the beam 26, such as located at a center of the beam 26, for example. In the processing and control by the control system 60, detected visual position information or data from the visual position information sensor 50 is received at the USB optical detection port 65 of the control system 60.

The detected visual position information or data from the optical detection port 65 is provided to a color analyzer 61 of the control system 60 having the ability to detect the different virtual sensors colors, such as the first, second and third colors of the color representations 54a, 54b and 54c, respectively. The processed detected virtual sensors' colors corresponding to the color representations 54a, 54b and 54c from the color analyzer 61 are provided to a first processor 62 of the control system 60 to determine or calculate a beam angle and a length of the beam 26, such as based on the detected different virtual sensors colors. The processed detected colors from the color analyzer 61 and the determined beam angle and the length of the beam 26 from the first processor 62 are provided to a second processor 63, such as a PID controller to calculate or determine an error or an adjustment in the location of the freely moveable object on the beam 26, such as the ball location of the ball 40 on the beam 26, and provide error correction or adjustment information to correct or adjust a position of the freely moveable object, such as the ball 40, to a desired position on the beam 26.

The error correction or adjustment information from the second processor 63 is provided to a beam position controller 64 to generate error correction or position adjustment control signals, such as commands, provided to the servo controller 31. Based on the received error correction or position adjustment control signals, the servo controller 31 generates one or more pulse width modulation (PWM) signals or PWM pulses to control operation of the servomotor 32 to adjust a position of the beam 26 by movement of the servomotor 32 to position the freely moveable object, such as the ball 40, at the desired position on the beam 26, based on the error correction or adjustment information from the second processor 63. The error correction or position adjustment control signals, such as commands, from the beam position controller 64, corresponding to generated PWM signals or PWM pulses by the servo controller 31, are provided to a “To Instrument” block 68 of the control system 60 to be provided therefrom to the servo controller 31 to control the servomotor 32 to adjust a position of the beam 26 to place the freely moveable object, such as the ball 40, at the desired position on the beam 26.

The servomotor 32 was desirably selected for use as an actuator in the beam tilt actuator 30 in the control and measurement training device 10 because the servomotor 32 typically does not require any driving circuits and only requires pulse-width modulation (PWM) pulses or PWM signals to initialize or generate motion to move the beam 26 to move the freely moveable object, such as the ball 40, on the beam 26. The at least one PWM pulse generated by the servo controller 31 depends upon the detected visual position information detected by the at least one visual position information sensor 50, such as an optical sensor, such as a webcam or a camera, for example.

When the visual position information sensor 50, such a camera or a webcam, detects visual position information that indicates the position of the freely moveable object, such as the ball 40, is not at a desired position along the beam 26, the control system 60, based upon the detected visual position information, will send one or more control signals, such as one or more commands, to the servo controller 31. Upon receiving the one or more control signals from the control system 60, the servo controller 31 generates at least one pulse, such as at least one PWM pulse, corresponding the received one or more control signals, and provides the at least one pulse to the servomotor 32 to command the servomotor 32 to rotate to a predetermined angle or to a predetermined position, such as to position the freely moveable object, such as the ball 40, at a desired position on the beam 26.

As described, the servo controller 31 can be any of a number of available suitable devices, as can depend on the use or application, and should not be construed in a limiting sense. As an example of such, the present system desirably incorporates an SC-8000 servo controller. The advantage of using the SC-8000 (or other) servo controller as the servo controller 31 is that when connected to the USB port such as of the control system 60, it will appear as a communication (COM) port to the control system, such as to the control system 60, or to a computer associated with the control system, of the control and measurement training device 10 and, thus, it will facilitate communication as a serial port from MATLAB, for example.

However, a serial driver typically must be installed in or in conjunction with the control system, such as the control system 60, or an associated computer prior to using the SC-8000 servo controller, in order to recognize the servo controller, such as the servo controller 31, when connected to the control system 60 or a computer associated with control system 60. Various serial drivers can be used, with an example of such being the Cypress USB to Serial Driver, as can depend on the use or application, and should not be construed in a limiting sense. This results in the servo controller 31, such as a SC-8000 servo controller, being recognized as a serial port by the computer device manager, such as associated with the control system 60, for example.

In order to communicate with servo controller 31, such as the SC-8000 servo controller, as a serial port, a communication protocol is required, such as can consist of two bytes for synchronization. Also, other suitable communication protocols can be used, as can depend on the use or application, and should not be construed in a limiting sense. For example, using the two byte communication protocol, a beginning of the communication with the servo controller 31, such as by the control system 60, typically can include either two tildes (˜ ˜) or decimals, e.g., “126”.

A one byte servo axis mask control signal, such as a command, is then sent by the control system 60 to the servo controller 31 in order to specify which servomotor 32 to access. For example, in this case the servo mask number 3 is to be used, and hence the mask that will be sent is 00010000 in binary representation, or 20 in a decimal representation. Following that, a one byte digital input/output (IO) mask control signal is sent to the servo controller 31. Finally, control signal(s) of two bytes of servo position data representing the servo pulse width are sent from the control system 60 to the servo controller 31. These two bytes of data typically are separated into a high byte and a low byte, with the high byte preceding the low byte. The control data control signals will be sent from the analysis environment, i.e., MATLAB/Simulink, operating on the control system 60 to the “To Instrument” block 68 in the lower right portion of the control system 60 illustrated in FIG. 3A and provided to the servo controller 31 of the servomotor 32 (FIGS. 1 through 2B).

It should be understood that the calculations and determinations performed by the control system 60 to provide process control to position the freely moveable object, such as the ball 40, at a desired position on the beam 26, can be performed by any suitable computer system, all or part of which can be incorporated with the control and measurement training device 10, such as in communication with or in conjunction with the servo controller 31 to control the servomotor 32 and in communication with or in conjunction with the at least one visual position information sensor 50, as illustrated in FIG. 1, for example, and such as that diagrammatically shown in FIG. 3B.

FIG. 3B is a block diagram illustrating a generalized control system 100, such as can be in conjunction with the servo controller 31 to control operation of the servomotor 32, and can be in conjunction with the at least one visual position information sensor 50, to implement control processes in embodiments of a control and measurement training device, such as the control and measurement training device 10. The generalized control system 100 can represent, for example, a stand-alone computer, computer terminal, portable computing device, networked computer or computer terminal, a networked portable device, a programmable logic controller (PLC) or an application specific integrated circuit (ASIC) and an associated display, for example, and should not be construed in a limiting sense.

Data is entered into system 100 via any suitable type of user interface 116, and can be stored in memory 112, which can be any suitable type of computer readable and programmable memory and is desirably a non-transitory, computer readable storage medium. Calculations are performed by processor 114, which can be any suitable type of computer processor and can be displayed to the user on display 118, which can be any suitable type of computer display, such as a liquid crystal display (LCD) or a light emitting diode (LED) display.

Processor 114 can be associated with, or incorporated into, any suitable type of computing device, for example, a personal computer, a programmable logic controller (PLC), or an application specific integrated circuit (ASIC). The display 118, the processor 114, the memory 112 and any associated computer readable recording media are in communication with one another by any suitable type of data bus, as is well known in the art. The generalized control system 100 implements by the processor 114 a programming method, such as in Matlab, as described, as can be stored in the memory 112, having the operations or instruction to adjust a position of the beam 26 to position the freely moveable object, such as the ball 40, at a desired position on the beam 26, based on the detected visual position information, such as from and detected by at least one visual position information sensor 50, for example.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that can be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media can include various suitable types of computer-readable media, and should not be construed in a limiting sense.

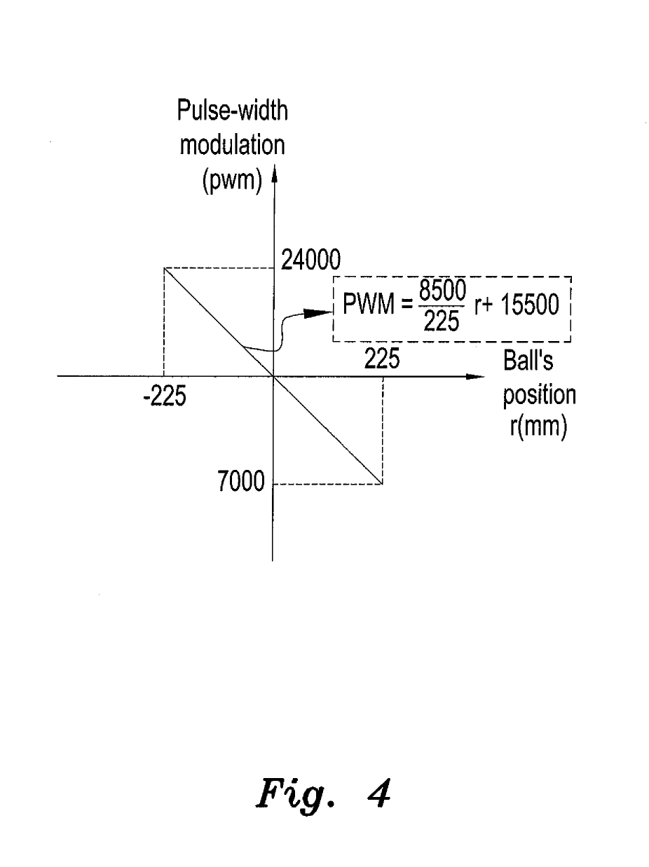

FIG. 4 illustrates the linear relationship between PWM and the position of the ball 40 along the beam 26. This graph represents an apparatus wherein the length of the beam 26 is 450 mm, as indicated by the extreme ball position of 225 to each side of center. However, a more generalized formulation can be established because the developed algorithm is capable of measuring the length of the beam automatically. Test results, such as indicated from FIG. 4, have shown that the beam angle measurement, ball tracking, and balancing control of the optical feedback system are relatively accurate, robust, and highly efficient.

It is to be understood that the present invention is not limited to the embodiments described above, but encompasses any and all embodiments within the scope of the following claims.

1-20. (canceled)

21. A training method for analyzing and controlling relative movement of objects comprising the steps of:
providing a training device comprising:
a portable base having opposed first and second sides, opposed first and second ends, and an upper surface;
a beam support extending upward from the upper surface of the base adjacent the first side and the first end thereof; the beam support having an upper end;
a beam tilt actuator mounted upon the upper surface of the base adjacent the first side and the second end thereof;
a selectively actuated rotary drive member extending from the beam tilt actuator;
a connecting rod eccentrically attached to the rotary drive member, the connecting rod having a distal end;
a substantially rigid elongate beam having a first end pivotally attached to the upper end of the beam support and a second end opposite the first end, the second end being pivotally connected to the distal end of the connecting rod;
a first stop extending upward from the first end of the beam, the first stop serving as a first virtual sensor;
a second stop extending upward from the second end of the beam, the second stop serving as a second virtual sensor;
laterally opposed first and second ball retaining wires extending between the first stop and the second stop, and a ball track being defined between the first and second ball retaining wires;
a freely rolling ball adapted to be disposed atop the beam between the first and second stops and between the first and second ball retaining wires, the ball being adapted to travel along the ball track, the ball serving as a third virtual sensor;
at least one visual position information sensor mounted atop the upper surface of the base, adjacent the second side thereof, the at least one visual position information sensor adapted to detect visual position information corresponding to a position of the ball on the beam; and
a controller to adjust a position of the beam to position the ball at a desired position on the beam based on the detected visual position information, the controller communicating with beam tilt actuator;
capturing real-time images of the training device with the at least one visual position information sensor during operation;
converting each real-time image into a RGB formatted image;
separating the three virtual sensors from background in each RGB formatted image;
converting each RGB formatted image into a gray-scale image;
converting each gray-scale image into a black and white image based upon a predetermined pixelated threshold value;
determining centroids of the three virtual sensors from each black and white image;
determining position of the ball with respect to the first and second stops based upon the centroids of the three virtual sensors utilizing a predetermined coordinate system;
calculating error in the ball's position with respect to the desired position set by a user;
calculating corrective measures based upon the calculated error to generate control signals to be sent to the beam tilt actuator; and
adjusting the ball's position to the correct position by sending the control signals through the controller.

22. The training method for analyzing and controlling relative movement of objects of claim 21, wherein said three virtual sensors comprises:
a first color tag having a first color disposed on said first stop of said beam;
a second color tag disposed on said second stop of said beam, said second color tag having a second color contrasting in color with said first color of said first color tag; and
said ball having a third color disposed thereon, said third color contrasting in color with said first color of said first color tag and said second color of said second color tag;
wherein the at least one visual position information sensor comprises at least one of a color camera or a color webcam that provides said detected visual position information corresponding to said first, second, and third colors.

23. The training method for analyzing and controlling relative movement of objects of claim 22, wherein said first, second, and third colors are selected from the visible spectrum having wavelengths in a range of from about 4,000 angstroms to about 7,000 angstroms.

24. The training method for analyzing and controlling relative movement of objects of claim 22, wherein the first, second, and third colors are selected from the group consisting of red, green, and blue.

25. The training method for analyzing and controlling relative movement of objects of claim 21, further comprising:
a substantially vertical sensor support mast extending upward from said upper surface of said base adjacent said second side thereof, at least one said visual position information sensor being vertically adjustably disposed on the mast.

26. The training method for analyzing and controlling relative movement of objects of claim 21, further comprising:
a control system associated with the controller, said control system being adapted to communicate with said at least one visual position information sensor to receive said detected visual position information and being adapted to communicate with said beam tilt actuator to provide one or more control signals to adjust a position of said beam to position said ball at the predefined position, based on the detected visual position information.

27. The training method for analyzing and controlling relative movement of objects of claim 21, wherein said beam tilt actuator comprises a servomotor to drive said rotary drive member to adjust position of said beam to correspond to the desired position of the ball on the beam.

28. The training method for analyzing and controlling relative movement of objects of claim 21, wherein the step of determining centroids comprises the step of using Blob Analysis.

29. The training method for analyzing and controlling relative movement of objects of claim 21, wherein the step of generating corrective measures comprises generating pulse-width modulation (PWM) signals to be sent to said controller.

30. A control and measurement training method comprising the steps of:
providing a first virtual sensor, a second virtual sensor, and a third virtual sensor; the first virtual sensor being a first stop on a tillable beam, the second virtual sensor being a second stop spaced from the first stop on the beam, and the third virtual sensor being a rotary ball translating on the beam between the first and second stops;
capturing real-time images of the virtual sensors with an at least one visual position information sensor during operation, the at least one visual position information sensor adapted to detect visual position information of objects;
converting each real-time image into a RGB formatted image;
separating the virtual sensors from background in each RGB formatted image;
converting each RGB formatted image into a gray-scale image;
converting each gray-scale image into a black and white image based upon a predetermined pixelated threshold value;
determining centroids of the virtual sensors from each black and white image;
determining position of the ball with respect to the first and second stops based upon the centroids of the three virtual sensors utilizing a predetermined coordinate system;
calculating error in the ball's position with respect to a desired position set by a user;
calculating corrective measures based upon the calculated error to generate control signals; and
adjusting the ball's position to the correct position by sending the control signals through a control system to tilt the beam.

31. The control and measurement training method of claim 30, wherein said virtual sensors comprises:
a first color tag having a first color disposed on said first stop;
a second color tag disposed on said second stop, said second color tag having a second color contrasting in color with said first color; and
said ball having a third color disposed thereon, said third color contrasting in color with said first color and said second color;
wherein said at least one visual position information sensor comprises at least one of a color camera or a color webcam that provides said detected visual position information corresponding to said first, second, and third colors.

32. The control and measurement training method of claim 31, wherein said first, second, and third colors are selected from the visible spectrum having wavelengths in a range of from about 4,000 angstroms to about 7,000 angstroms.

33. The control and measurement training method of claim 31, wherein the first, second, and third colors are selected from the group consisting of red, green, and blue.

34. The control and measurement training method of claim 30, wherein said control system comprises:
a beam tilt actuator adapted to selective tilt said beam; and
a controller communicating with said beam tilt actuator and said at least one visual position information sensor, said controller receiving said detected visual position information and sending said control signals to said beam tilt actuator to adjust position of said beam to position said ball at the desired position based on said detected visual position information.

35. The control and measurement training method of claim 34, wherein said beam tilt actuator comprises a servomotor.

36. The control and measurement training method of claim 30, wherein the step of determining centroids comprises the step of using Blob Analysis.

37. The control and measurement training method of claim 30, wherein the step of generating corrective measures comprises generating pulse-width modulation (PWM) signals to be sent to said control system.
